(19) United States
(12) Patent Application Publication
(10) Pub. No.: US 2026/0053279 A1
(43) Pub. Date: Feb. 26, 2026

(54) Vending Machine with Improved Cabinet

(71) Applicants: Clifton Dwayne Tally, Boerne, TX (US); JeVon Thomas McCormick, Liberty Hill, TX (US)

(72) Inventors: Clifton Dwayne Tally, Boerne, TX (US); JeVon Thomas McCormick, Liberty Hill, TX (US)

(21) Appl. No.: 19/305,695

(22) Filed: Aug. 20, 2025

Related U.S. Application Data
(60) Provisional application No. 63/685,982, filed on Aug. 22, 2024.

(51) Int. Cl. A47F 3/02; B65F 1/14; G09F 23/06

(52) U.S. Cl. CPC A47F 3/02; B65F 1/1426; G09F 23/06

(57) ABSTRACT

A vending machine with an improved cabinet design is disclosed. The cabinet is constructed with a tapered configuration wherein the rear portion is narrower than the front, enabling optimal installation in architectural corners, against curved surfaces, or within circular floorplans. The machine comprises integrated audiovisual components, energy-efficient lighting, secure payment infrastructure, and modular connectivity for digital advertisement display and vending operations, along with other optional features. Optional features include AI-based product tracking, camera for security and/or product management (29) and a multi-use housing structure in the lower section of the machine that incorporates waste disposal (26) and/or print advertising (25). This invention expands both the placement flexibility and multifunctional capability of vending systems in constrained and high-traffic environments.

### 2. CROSS-REFERENCE TO RELATED APPLICATIONS

This application claims the benefit of U.S. Provisional Application No. 63/685,982 filed Aug. 22, 2024.

### 3. FIELD OF INVENTION

The present invention relates to automated retail devices and, more specifically, to a vending machine designed with uniquely tapered cabinet configurations.

### 4. BACKGROUND OF THE INVENTION

The invention comprises an ornamental design for one or more vending machine apparatuses and vending machine user interfaces to be used in unconventional locations, including corners or similar dead spaces, along curved surfaces or in open floor plans, as depicted in certain of the figures and described in portions of the associated description.

In conventional environments—such as retail stores, entertainment venues, theme parks, transit centers, and hospitality locations—interior and exterior structural layouts often feature non-linear geometries including corners and curved surfaces. These spatial features frequently result in “dead zones” that are unsuitable for standard square or rectangular vending machines, thereby representing lost opportunities for both product distribution and advertising revenue.

Traditional vending machines are generally box-shaped, consuming substantial floor area and/or requiring placement against flat surfaces. The vending machine disclosed herein features a cabinet with a narrowed posterior section and expanded anterior section via left and right sidewalls that are tapered inward. This allows the unit to occupy minimal footprint while enabling integration into unused spaces. Additionally, the design permits multiple machines to be arranged in modular configurations—either in a contiguous arc along curved architectural surfaces or radially in a full circle—thus maximizing commercial utility in constrained areas but high-traffic environments. Energy-efficient lighting and motion-activated sensors can also be incorporated to minimize power consumption.

### 5. SUMMARY OF THE INVENTION

The invention provides a vending machine with an angularly tapered cabinet suitable for efficient placement into architectural corners or along non-linear walls. The structure further enables clustered installations in a semi-circular or full-circular orientation for optimized retail presence and advertisement dissemination. Key features include a reduced physical footprint, ability for a modular construction framework, compatibility with modern payment methods, and integrated audiovisual engagement mechanisms for an enhanced customer experience.

### 6. DESCRIPTION OF DRAWINGS

FIG. 1: Front view of improved cabinet showing tapered left and right walls with back panel and adjustable legs.

FIG. 2: Front view of improved cabinet showing tapered left and right walls with back panel and wall mount brackets.

FIG. 3: Front view of improved cabinet showing tapered left and right walls with back panel and waste disposal with print advertising section.

FIG. 4: Front view of improved cabinet showing tapered left and right walls with back panel and wall mount brackets.

FIG. 5: Detailed view of wall mount.

FIG. 6: Top view of improved cabinet showing tapered left and right walls with back panel.

FIG. 7: Top view of multiple machines installed adjacently where the tapered shape allows semi-circular alignment. This configuration is ideal for curved walls in arenas, airports, or malls.

FIG. 8: Top view of multiple machines installed adjacently where the tapered shape allows a circular configuration, enabling 320-degree customer access. This configuration is ideal for trade shows, transit stations, or open event spaces.

FIG. 9: Rear view of improved cabinet showing tapered left and right walls with back panel and waste disposal with print advertising section.

FIG. 10: Bottom view of improved cabinet showing tapered left and right walls with back panel.

FIG. 11: Front view of improved cabinet showing LED light placement.

FIG. 12: Front view of cabinet with waste disposal and print advertising section.

FIG. 13: Front view of improved cabinet showing tapered left and right walls and adjustable legs. This configuration allows for additional space in body of machine.

FIG. 14: Front view of improved cabinet showing tapered left and right walls and wall mount brackets.

FIG. 15: Front view of improved cabinet showing tapered left and right walls with waste disposal and print advertising section.

FIG. 16: Front view of improved cabinet showing tapered left and right walls with wall mount brackets.

FIG. 17: Detailed view of wall mount.

FIG. 18: Rear view of improved cabinet showing tapered left and right walls with waste disposal with print advertising section.

FIG. 19: Bottom view of improved cabinet showing tapered left and right walls

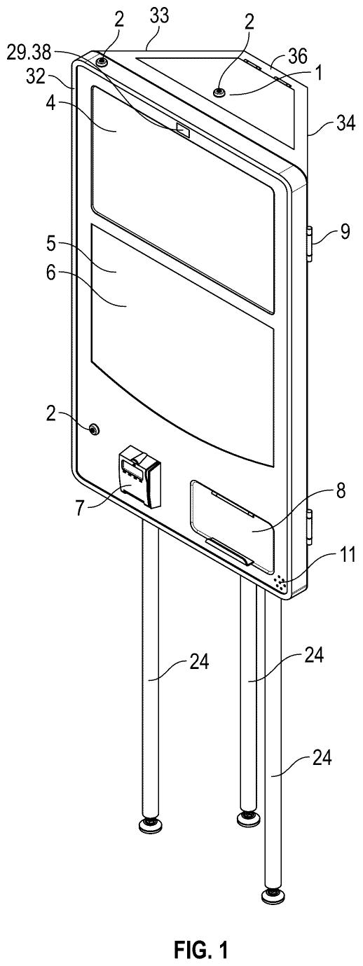

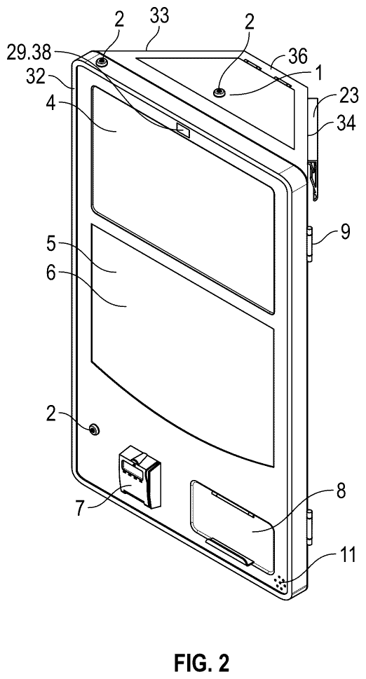

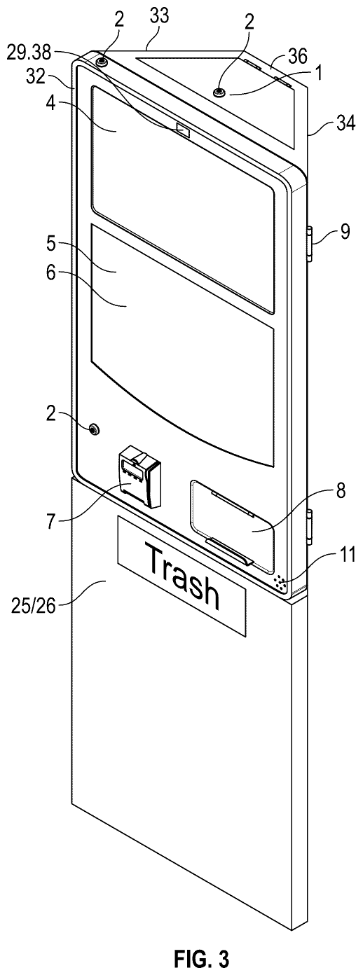

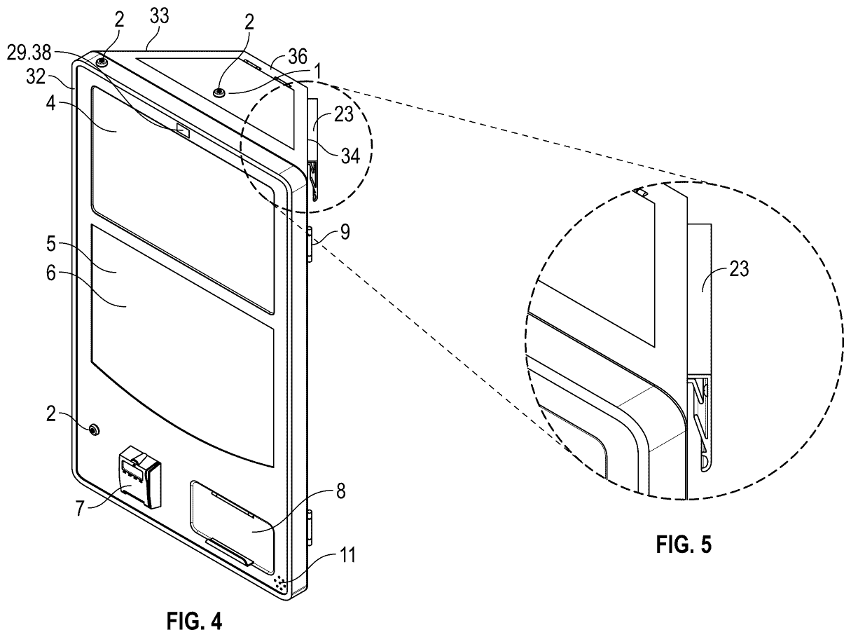

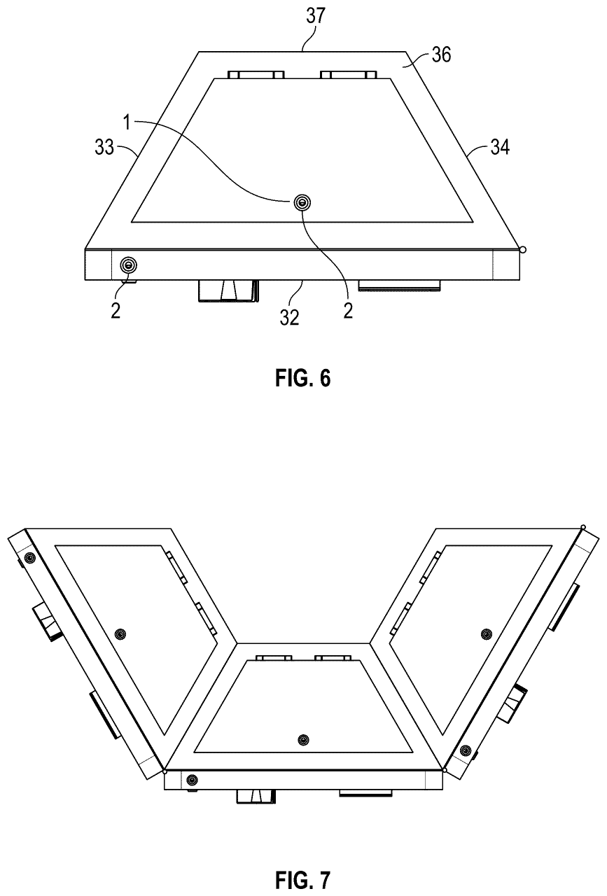

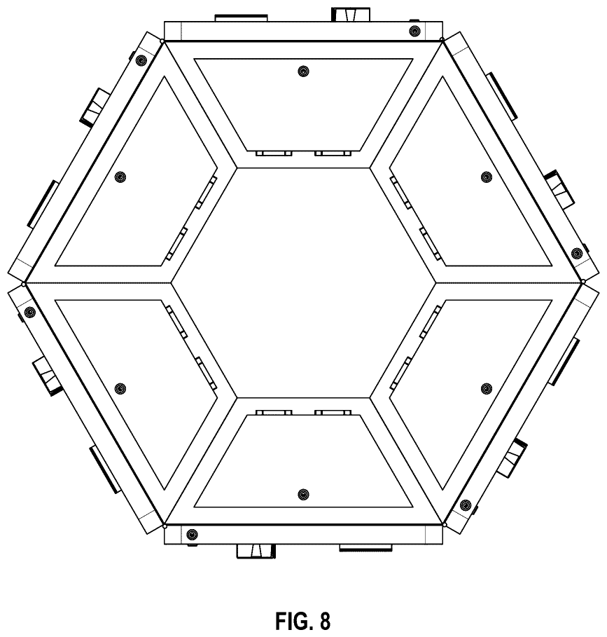

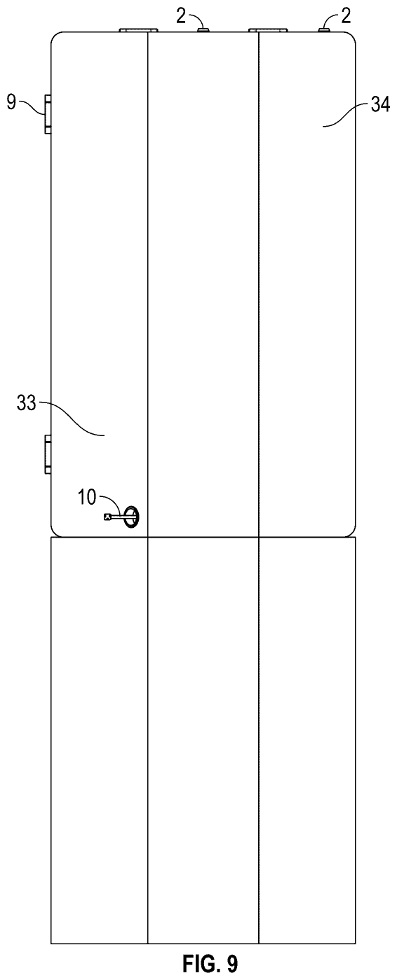

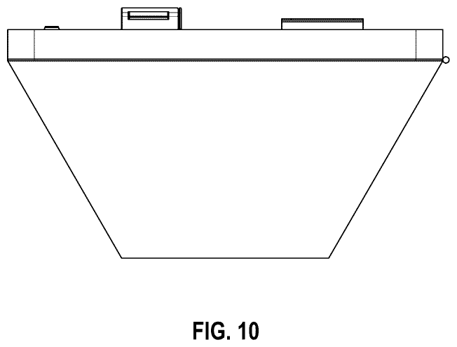

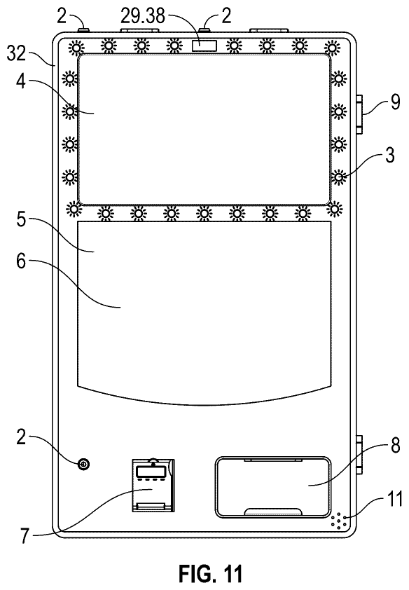

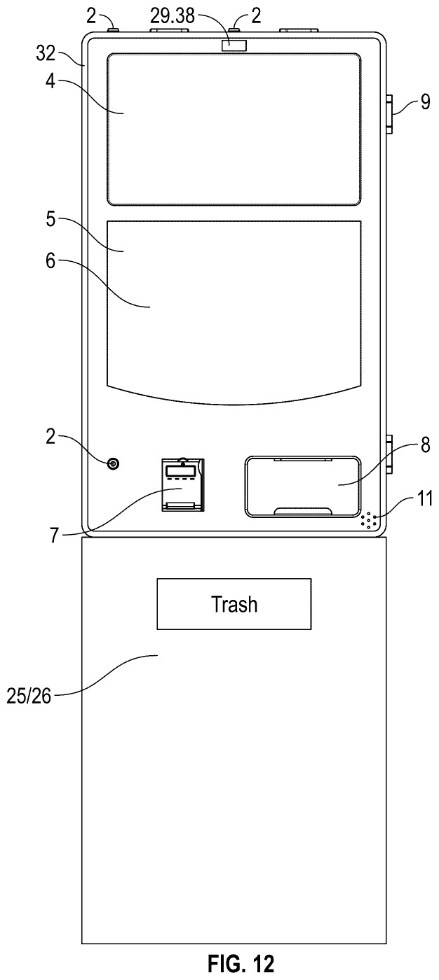

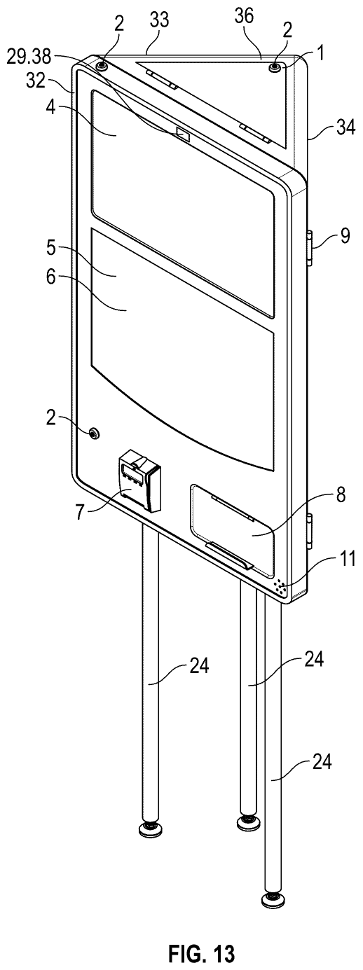

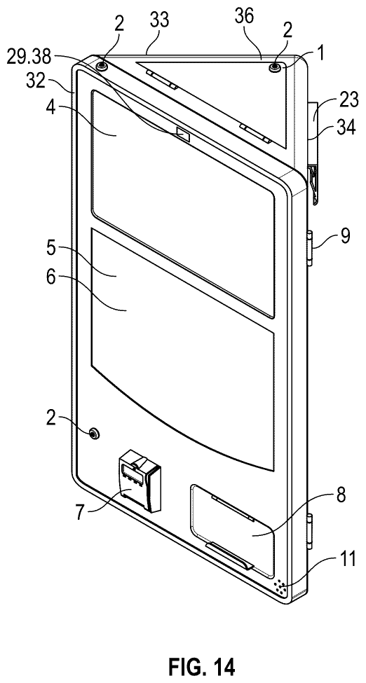

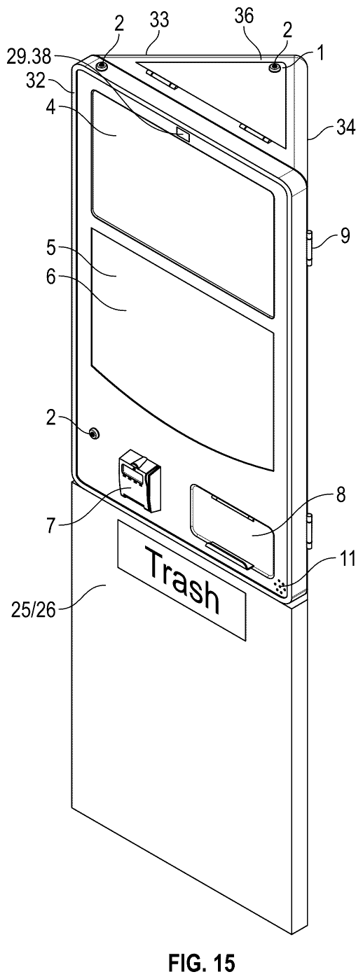

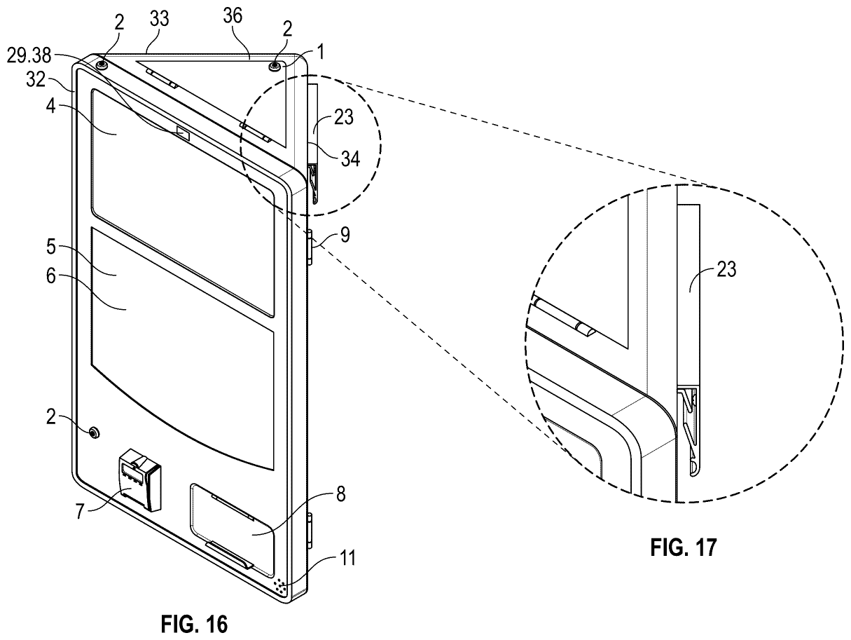

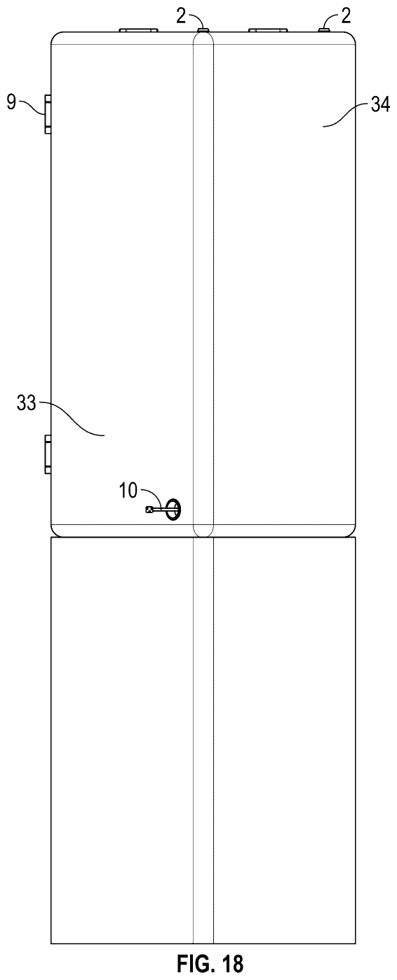

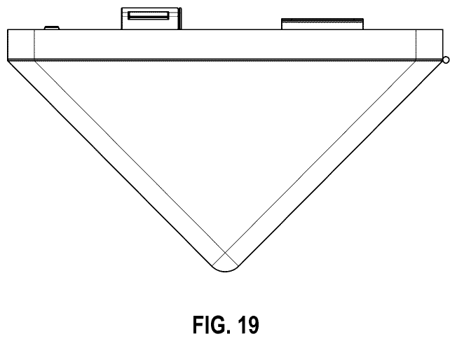

### 7. DETAILED DESCRIPTION OF THE INVENTION

The invention comprises a vending machine characterized by a cabinet (31) with left tapered sidewall (33) and right tapered sidewall (34) converging toward a narrower posterior end and diverging toward a wider anterior front panel (32). The top (36) and bottom (35) panels enclose the vertical structure. In alternative embodiments where the cabinet shape does not form a triangular configuration—such as a trapezoidal design or other variant geometries—a rear panel (37) may be necessary to fully enclose the unit. This rear panel (37) may consist of a solid backing constructed from the same material as the cabinet sidewalls, or it may include integrated ports or openings for ventilation or cable access. The rear panel (37) ensures structural rigidity and environmental protection in applications where sidewalls alone do not provide full enclosure.

Core features include:
HD digital display (4)
Transparent front product viewing section (5)
Programmable LED lighting system (3)
Payment gateway system (7) including a Wi-Fi module (19), PCI-compliant processor (21) and encryption module (22)
Integrated audio speakers (11)
Dispensing hopper system comprising: capsule guide ramp, chute, slot holder, protector spring, and dispensing coils
Modular capsule container
Tamper detection sensor and alarm
Pickup access compartment (8)
Mechanical hinges (9) for maintenance access
Content Management System (CMS) software for advertisement and vending logic control

Additional optional elements include:
Wall bracket hanger (23)
Adjustable leg stands (24)
Advertising panel for print ads (25) or waste disposal housing (26)
Ethernet and cellular connectivity
Camera (29)
AI-based inventory software

### 8. RELATIONSHIP BETWEEN COMPONENTS

Each vending machine includes an exterior cabinet assembly supporting interior dispensing and payment systems. The front panel (32) contains a high-definition video display (4) at the top center, below which is a transparent product view window (5) with visibility into the hopper (6) where products are stored. LED lighting (3) surrounds the display and is controlled via the internal CMS (20). The payment system (7) supports multiple transaction methods, while digital advertisements are controlled by the CMS and updated via the Wi-Fi or alternative network modules.

Several dispending methods can be incorporated into the machine based on desired application. For this example, the dispensing mechanism accepts product capsules through a hopper access door (1) and uses a combination of rotating coils, guide ramps, and slot holders to direct the capsule into the pickup access compartment (8) post-payment. The entire system is enclosed securely and accessed for maintenance via panel hinges (9) and secured with barrel locks (2).

### 9. HOW THE INVENTION WORKS

Customers initiate interaction with the machine by approaching and engaging with the HD digital display (4), which plays looped or reactive video advertisements or could be in “sleep mode” and is awaken by using a motion sensor or camera (29, 38) when a customer walks into range. The customer views available products in the hopper (6). Upon deciding to make a purchase, the customer selects a product—if multiple are available—and completes the transaction using the payment gateway (7). Transaction data is encrypted, processed securely and transmitted over a network.

Once authorized, one of several dispensing methods may be triggered:
1. Rotary Coil Dispensing: A coil rotates to release a capsule into the guide ramp, which funnels the item through the chute and into the pickup compartment (8). Configuration of the chute will be unique to accommodate the modified shape of the cabinet.
2. Rotary Lever Mechanism: A mechanical rotary lever pushes the product capsule forward from a resting slot, displacing it over an edge where gravity causes the item to fall into the pickup compartment area.
3. Precision Grab-and-Retrieve System: For more advanced selections, a robotic arm or belt-driven grabber mechanism aligns with the selected item and retrieves it from a specific storage bay, transporting it to the pickup compartment.

Each method is synchronized with the CMS and inventory tracking to ensure correct fulfillment. Tamper sensors and alarm (12) monitor for unauthorized access.

### 10. HOW TO MAKE THE INVENTION

Manufacturing involves constructing the modular cabinet assembly from prefabricated wall panels (32-37), with tapering engineered into the left (33) and right (34) sidewalls. Internal components are commercially sourced, including the dispensing mechanisms, payment systems, and audiovisual modules. Components are installed in designated housing locations, and system integration is completed by programming the CMS and network communications.

Standard electrical components, cooling systems (if needed), and optional AI modules may be added to expand functionality into smart retail and open-market applications.

### 11. HOW TO USE THE INVENTION

To install and operate the vending machine:

### 1. Installation by Operator

Select an appropriate architectural location—preferably a corner, wall curvature, or open area.
Ensure proximity to an electrical power source to connect power cable/supply (10).
Deploy as a single unit or modular configuration.
For corner use: orient machine so rear corner or panel abuts the wall intersection.
For curved wall use: align multiple machines with tapered sides flush to create an arc.
For open space: install in radial circle with customer access on all sides.
Mount on leg stands (24) or wall brackets (23) as needed.
Connect to Wi-Fi or alternative network module.

### 2. Configuration by Operator

Upload advertising assets and vending configurations to the CMS platform.
Set product pricing, schedules, and display parameters.
Load product capsules into the hopper (6) via the hopper access door (1).

### 3. Customer Interaction

Customer views or interacts with digital display (4) advertisements and sees specific products offered within the hopper (6). Customer also may hear advertising through integrated audio speakers (11).
Optional: QR code/NFC ad engagement triggers promotional offers.
To purchase, customer initiates a transaction at the payment gateway.
On authorization, product is dispensed into the pickup compartment.

This design enables dual revenue generation from both product vending and interactive digital advertising, optimized within spaces traditionally unserviceable by standard vending form factors. 1. A vending machine, comprising:
a cabinet having a front panel and a rear portion,
left and right sidewalls extending between the front panel and the rear portion,
wherein the sidewalls taper inward from the front panel toward the rear portion such that the rear portion is narrower than the front panel.

2. The vending machine of claim 1, wherein the cabinet has a trapezoidal cross-section.

3. The vending machine of claim 1, further comprising a wall bracket or adjustable leg stand for selective mounting options.

4. The vending machine of claim 1, further comprising a lower cabinet portion configured to house a print advertising panel and/or a waste disposal compartment.

5. The vending machine of claim 1, wherein a plurality of the vending machines are arranged in an semi-circle to align against a curved surface.

6. The vending machine of claim 1, wherein a plurality of the vending machines are arranged radially to form a circular configuration with customer access around the periphery.
